(19) United States
(12) Patent Application Publication
(10) Pub. No.: US 2025/0268228 A1
(43) Pub. Date: Aug. 28, 2025

(54) WET PET FOOD DISPENSER

(71) Applicant: Seungjoo KEE, Richmond (CA)

(72) Inventor: Seungjoo KEE, Richmond (CA)

(21) Appl. No.: 19/021,072

(22) Filed: Jan. 14, 2025

Related U.S. Application Data
(60) Provisional application No. 63/557,242, filed on Feb. 23, 2024.

(51) Int. Cl. A01K 5/01; A01K 5/02

(52) U.S. Cl. CPC A01K 5/0114; A01K 5/0208

(57) ABSTRACT

In one aspect, a device for automatically serving wet pet food includes a body and a lid removal bay in the body configured to receive a pet food pod. The pod includes a container portion containing wet pet food. The pod is generally bowl-shaped and has a rim. The pod further includes a lid, peelably and hermetically sealed to the rim, having a peripheral tab. The device further includes a tab engaging element configured to engage the tab and a lid removal actuator operable to actuate the tab engaging element along a trajectory over a pet food pod in the lid removal bay so that the tab engaging element will engage and pull the tab across the container portion to cause the lid to peel away from the rim. A retainer is configured to substantially immobilize the pod within the lid removal bay during lid removal.

### CROSS-REFERENCE TO RELATED APPLICATIONS

The present application claims the benefit of U.S. Provisional Patent Application No. 63/557,242 filed on Feb. 23, 2024, which is hereby incorporated by reference hereinto.

### TECHNICAL FIELD

The present disclosure relates to pet food, and more particularly to a device for automatically serving wet pet food.

### BACKGROUND

Dry food for house pets, such cats or dogs, is shelf-stable and convenient. However, in some respects, dry pet food may not be as healthy for pets as wet pet food. For example, eating solely dry pet food may leave some cats insufficiently hydrated because cats may lack a strong thirst drive. Pets may also find dry pet food to be less appetizing than wet pet food. This may lead to pet undernourishment.

### SUMMARY

In one aspect of the present disclosure, there is provided a device for automatically serving wet pet food, the device comprising: a body; a lid removal bay in the body, the lid removal bay configured to receive a pet food pod, the pet food pod including a container portion containing wet pet food, the container portion being generally bowl-shaped and having a rim, the pet food pod further including a lid peelably and hermetically sealed to the rim, the lid having a peripheral tab; a tab engaging element configured to engage the peripheral tab; a lid removal actuator in the body, the lid removal actuator operable to, upon receipt of the pet food pod within the lid removal bay, actuate the tab engaging element along a trajectory over the pet food pod so that the tab engaging element will engage and pull the tab across the container portion to cause the lid to peel away from the rim, resulting in an open container portion with exposed wet pet food; and a retainer configured to substantially immobilize the pet food pod within the lid removal bay during lid removal by the tab engaging element.

In some embodiments, the device further comprises a pod storage tower removably attached to the body, the pod storage tower for receiving a stack of the pet food pods.

In some embodiments, the pod storage tower includes a pod alignment feature for promoting a uniform orientation of the pet food pods in the stack received in the pod storage tower.

In some embodiments, the device further comprises a receiving bay in the body below the pod storage tower, the receiving bay configured to receive a pet food pod from the pod storage tower; and a pod lowering mechanism for lowering a lowermost pod from the pod storage tower into the receiving bay.

In some embodiments, the device further comprises a conveyor operable to convey a pet food pod from the receiving bay to the lid removal bay.

In some embodiments, the conveyor substantially maintains an orientation of the pet food pod during conveyance.

In some embodiments, the conveyor comprises a pair of parallel rails, the container portion of the pet food pod has a base with a pair of straight parallel grooves formed in an underside of the base, and the conveyor is operable to slidably translate the pet food pod atop the pair of parallel rails with each of the grooves seated on a respective one of the rails.

In some embodiments, the device further comprises a lid disposal tray within the body adjacent to the lid removal bay, the lid disposal tray being configured to hold a plurality of lids after removal of the lids from respective ones of the pet food pods.

In some embodiments, the device further comprises a feeding bay in the body configured to receive the open container portion of a pet food pod that has been conveyed from the lid removal bay, the feeding bay including an opening in a top surface of the body, the opening being surrounded by an inwardly facing lip, the lip being configured to obstruct pod removal from the feeding bay without obstructing access to wet pet food within the container portion.

In some embodiments, the device further includes a pod disposal chamber configured to receive a plurality of pet food pod container portions, in a substantially empty state, conveyed from the feeding bay.

In some embodiments, the device further includes a compactor mechanism operable to compact the plurality of pet food pod container portions, in the substantially empty state, within the pod disposal chamber.

In some embodiments, the pod disposal chamber includes a removable pod disposal tray having a pair of longitudinal curbs and a floor between the curbs recessed downwardly relative to the curbs.

In some embodiments, the pod disposal chamber includes a removable pod disposal tray having a floor and a plurality of crosswise grooves or ridges on the floor, each of the crosswise grooves or ridges being configured to catch the rim of a respective one of the pet food pod container portions to discourage slippage of the pet food pod container portion towards a front of the pod disposal tray.

In some embodiments, the device further comprises a fan within the body; and a removable filter positioned in an airflow path of the fan, the removable filter configured to absorb or neutralize odors from air circulated by the fan, the filter being removably secured within the device.

### BRIEF DESCRIPTION OF THE DRAWINGS

In the figures which illustrate example embodiments:

FIG. 1 is a top perspective view of an example pet food pod embodiment;

FIG. 2 is a bottom perspective view of the example pet food pod of FIG. 1;

FIG. 3 is an exploded view of the pet food pod of FIGS. 1 and 2;

FIGS. 4, 5, 6, 7, 8, and 9 are schematic views of a device for automatically serving wet pet food at various stages of operation;

FIG. 10 depicts an example pet food pod with a partially opened lid as it may appear when the device is at the stage of operation depicted in FIG. 6;

FIG. 11 depicts an example pet food pod with a mostly opened lid as it may appear when the device is at the stage of operation depicted in FIG. 7;

FIG. 12 is a front top right perspective view of an embodiment of a device for automatically serving wet pet food;

FIG. 12A is a schematic view of part of the device of FIG. 12;

FIG. 13 is a side elevation view of an alternative embodiment of pet food pod that may be loaded into the device embodiment of FIG. 12; and

FIG. 14 is a top view of the pet food pod of FIG. 13.

### DESCRIPTION

The present disclosure describes a device for automatically serving wet pet food to a house pet. The device is operable to automatically open one or more sealed pods containing wet pet food that has/have been loaded into the device.

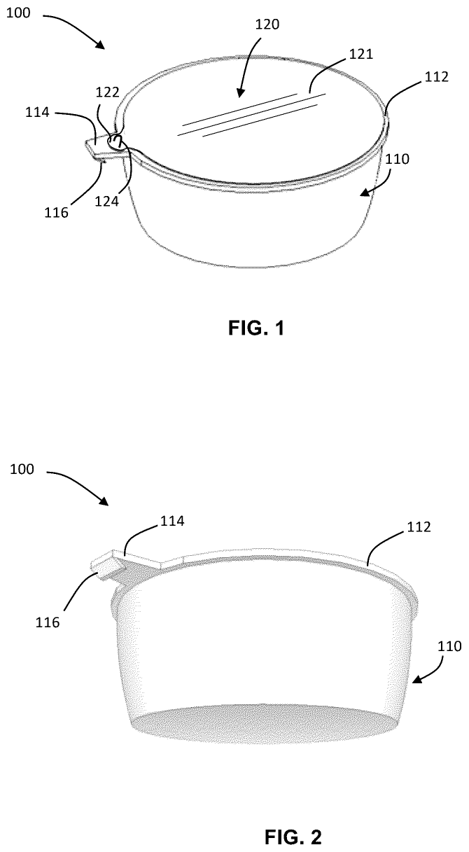

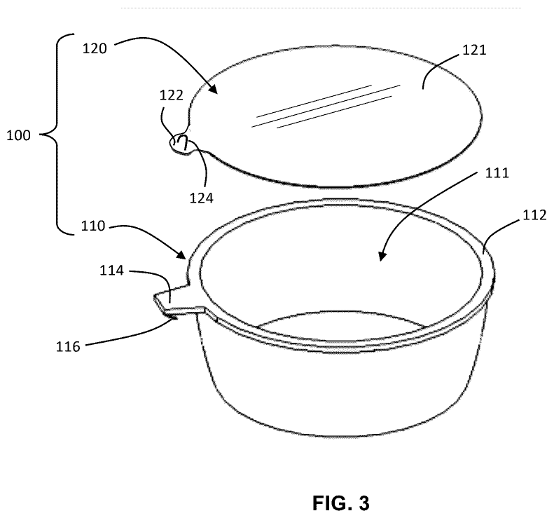

FIGS. 1 and 2 are a top perspective view and bottom perspective view, respectively, of a pet food pod 100 containing wet pet food. FIG. 3 is an exploded view of the pet food pod 100 of FIGS. 1 and 2 in which the wet pet food is omitted for clarity. The pet food pod 100 has a container portion 110 and a lid 120.

The container portion 110 is configured (e.g., shaped and sized) to contain a single serving of wet pet food that, with the lid 120 removed, can be eaten by a pet directly from the container portion 110. The container portion 110 is generally bowl-shaped with an open top 111, best seen in FIG. 3. The container portion 110 is made from a moisture-impermeable material, such as plastic. The container portion 110 has a rim 112, which in the present embodiment is an outwardly projecting annular flange having a flat upper surface.

A protrusion 114 extends laterally from the rim 112 on one side of the pet food pod 100. The protrusion 114 has a pod retention element 116. As will be appreciated, the pod retention element 116 may facilitate immobilization of the pet food pod 100 during removal of the lid 120. In the present embodiment, the pod retention element 116 is a lip (tab) that extends downwardly and inwardly from a distal end of the protrusion 114 (see, e.g., FIG. 2).

The lid 120 is formed of a moisture-impermeable material, such as foil or a foil material with a plastic undercoating. In the present embodiment, the lid 120 has a generally circular body portion 121 and an integral tab 122 extending from a periphery of the body portion 121 (i.e., a peripheral tab 122). The peripheral tab 122 is used during lid removal as described below. In the present embodiment, the peripheral tab 122 has an upstanding loop 124 of strong material, such as wire, nylon thread, or plastic filament, securely attached thereto. The loop 124 facilitates engagement of the tab 122 during lid removal and may thus be generically referred to as a tab engagement facilitating portion 124 of the tab 122. The material from which the loop 124 is made may be pliable or rigid and may have a sufficient degree of stiffness for loop 124 to be upstanding as shown in FIG. 1 for example. The upstanding profile of loop 124 may facilitate engagement of the peripheral tab 122 by some implementations of lid removal mechanisms, as will be described.

The pet food pod 100 may be sold with wet pet food contained in the container portion 110 and the lid 120 peelably and hermetically sealed to the rim 112 to keep the pet food fresh and moist. The lid 120 may be sealed to the rim 112 using a food-safe adhesive, which is not expressly depicted. The adhesive may be applied in a continuous ring that seals a periphery of the body portion 121 of the lid 120 to the upper surface of rim 112 but leaves the tab 122 unadhered to the protrusion 114 with which the tab 122 is aligned. Leaving the tab 122 unadhered to the container portion 110 may facilitate the initiation of lid removal, as will be described. The extent of the body portion 121 of the lid 120 may be less than the extent of the rim 112, i.e., the rim 112 may protrude outwardly peripherally from underneath the body portion 121 of lid 120. In some embodiments, the protruding portion of the rim 112 may facilitate stabilizing the pod 100 during lid removal, e.g., via one or more elements that engage with (hold down) the rim 112 without inhibiting removal of the lid 120, as will be described. The degree of protrusion of rim 112 from underneath the body portion 121 of lid 120 may vary and may be greater than what is shown in FIG. 1 for example.

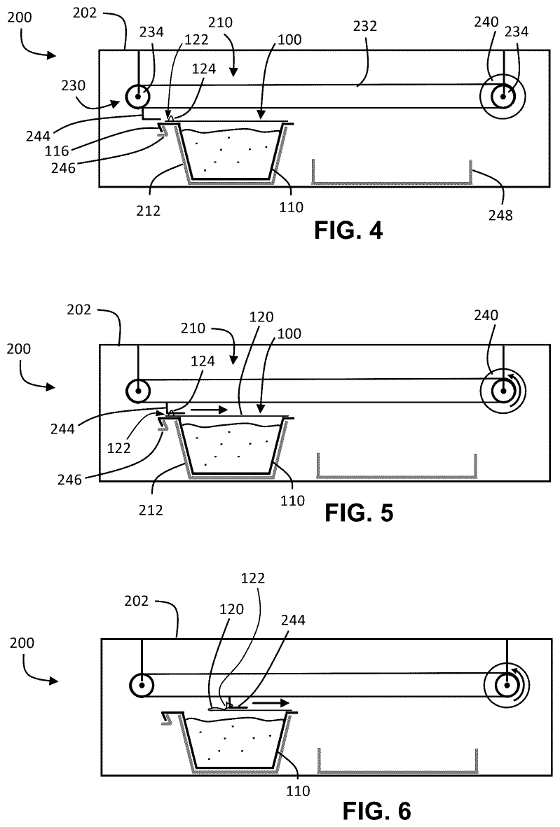

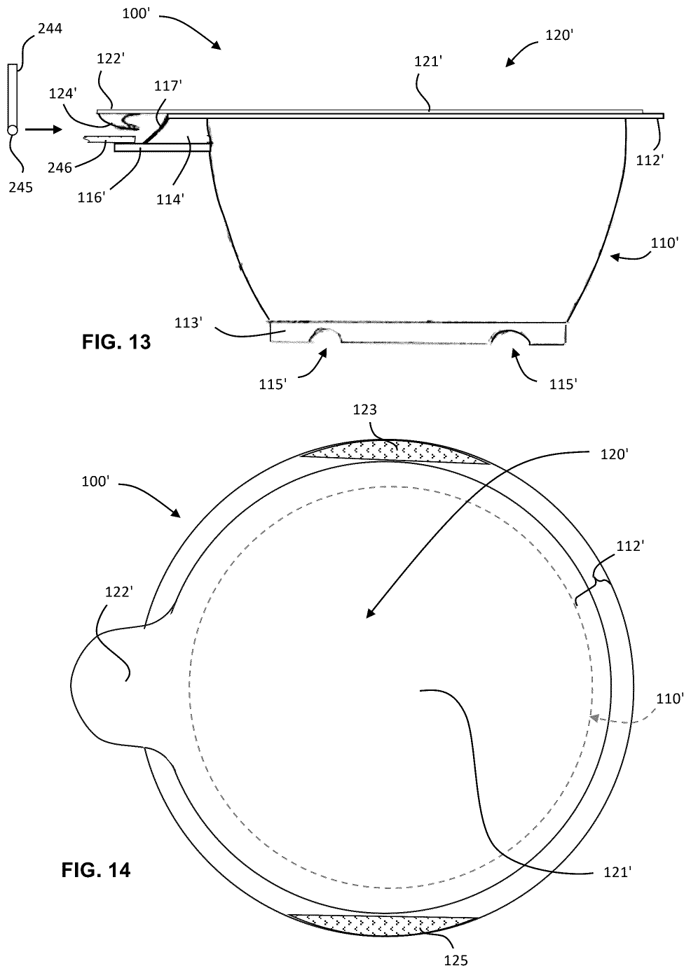

A device 200 for automatically serving wet pet food is schematically depicted in FIGS. 4-9 at various stages of operation. The device 200 is configured to receive at least one pet food pod 100 as depicted in FIGS. 1-3 (or pet food pod 100′ as depicted in FIGS. 13 and 14, described below) and to automatically open the pet food pod 100 for presentation to a house pet for consumption, e.g., at a time when the owner of the pet is away from home.

Referring to FIG. 4, the schematically depicted device 200 has a body 202 made from a rigid material, such as metal or plastic. A lid removal bay 210 is disposed within the body 202. The lid removal bay 210 is configured to receive a pet food pod 100, e.g., in a receptacle 212 that may be fixed with respect to the body 202.

Also disposed within the body 202 is a lid removal mechanism 230. The lid removal mechanism 230 is designed to facilitate automatic removal of the lid 120 of a pet food pod 100 that has been received in the lid removal bay 210. In the present embodiment, the lid removal mechanism 230 includes an endless drive member 232 (e.g., a chain or belt) looped around a pair of rotatable gears or pulleys 234. A lid removal actuator 240 (e.g., an electric motor) is operable to induce rotary motion of one of the gears or pulleys 234, causing the endless drive member 232 to loop around both gears or pulleys 234. A tab engaging element 244, which in this embodiment is an L-shaped hook, is attached to the endless drive member 232 as depicted.

The device 200 also includes a retainer 246. The retainer 246 is a physical component that is configured to substantially immobilize the pet food pod 100 within the lid removal bay 210 during removal of the lid 120 by the lid removal mechanism 230. The retainer 246 may have a complementary shape to that of the pod retention element 116 for engagement therewith and may be fixed with respect to the body 202. In this embodiment, the retainer 246 has an upstanding lip (or tab) that is angled away from the receptacle 212 at a complementary angle to that of the pod retention element 116.

The example device 200 further includes a lid disposal tray 248 adjacent to the lid removal bay 210. The lid disposal tray 248 is configured to receive at least one lid 120 that has been removed from a pet food pod 100. The lid disposal tray 248 may be removable to facilitate disposal of one or more lids 120 contained therein.

The device 200 may optionally include other elements and components which are omitted from FIGS. 4-9 for simplicity and clarity. Examples of other elements and components that may be included in the device 200 are described below.

In operation, the lid removal bay 210 receives a pet food pod 100 in receptacle 212 (see FIG. 4). The pet food pod 100 may be provided to the lid removal bay 210 in various ways. In one embodiment, a conveyor (not depicted) may convey the pet food pod 100 to the lid removal bay 210 from another area of device 200, such as a receiving bay below a pod storage tower, both of which are described below. Alternatively, the pet food pod 100 may be placed into the lid removal bay 210 manually in some embodiments, e.g., via an access door (not depicted) in the body 202 of the device 200.

When the pet food pod 100 is received in the receptacle 212, the retainer 246 engages the pod retention element 116, e.g., in an interlocking manner. Within the lid removal bay 210, the pet food pod 100 is oriented so that the protrusion 114, and thus tab 122 and loop 124, are aligned with the tab engaging element 244 of the lid removal mechanism 230.

Referring to FIG. 5, the lid removal actuator 240 of the lid removal mechanism 230 may be automatically activated, e.g., by a controller (not depicted) of the device 200, e.g., at a preset time of day, which may be user configurable. In this embodiment, activation of the actuator 240 causes the endless drive member 232 to rotate, which in turn causes tab engaging element 244 to begin to move (translate) to the right in FIG. 5. The tab engaging element 244 moves along a trajectory over the pet food pod 100 in which it will engage with the tab 122. More specifically, in this embodiment, the L-shaped hook of tab engaging element 244 engages with the tab 122 by passing through the tab engagement facilitating portion 124 (i.e., upstanding loop 124) of tab 122, as shown in FIG. 5.

Thereafter, the tab engaging element 244 continues to move along the trajectory defined by the endless drive member 232. In so doing, the tab engaging element 244 pulls tab 122, by way of loop 124, across the container portion 110 of the pet food pod 100. The retainer 246 helps to keep the pet food pod 100 immobilized within the lid removal bay 210 during lid removal by virtue of its engagement with the pod retention element 116. In some embodiments, immobilization of the pet food pod 100 may be further promoted by one or more elements that engage with a protruding portion of rim 112 (see FIG. 1). For example, rails (not depicted) forming part of the body 202 may be positioned on opposite sides of the pet food pod 100 directly over the protruding portion of rim 112, e.g., with each rail being offset approximately ninety degrees from the protrusion 114.

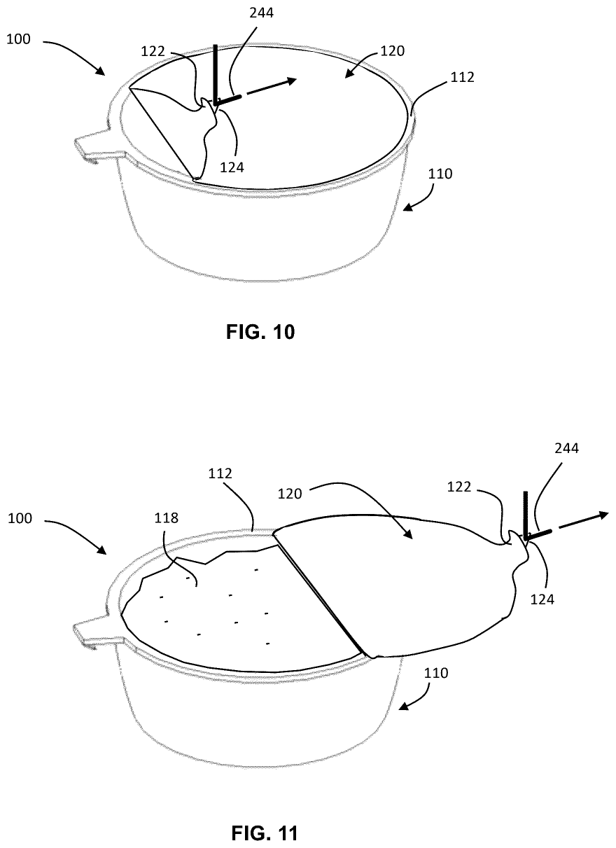

The force generated by the actuator 240 is sufficient for the pulling of tab 122 to cause the lid 120 to start to peel away from the rim 112 of the container portion 110. The lid folds over itself as it is peeled away, e.g., as shown in FIG. 6. A perspective view of the partially opened state of the pet food pod 100 at this stage of operation is provided in FIG. 10.

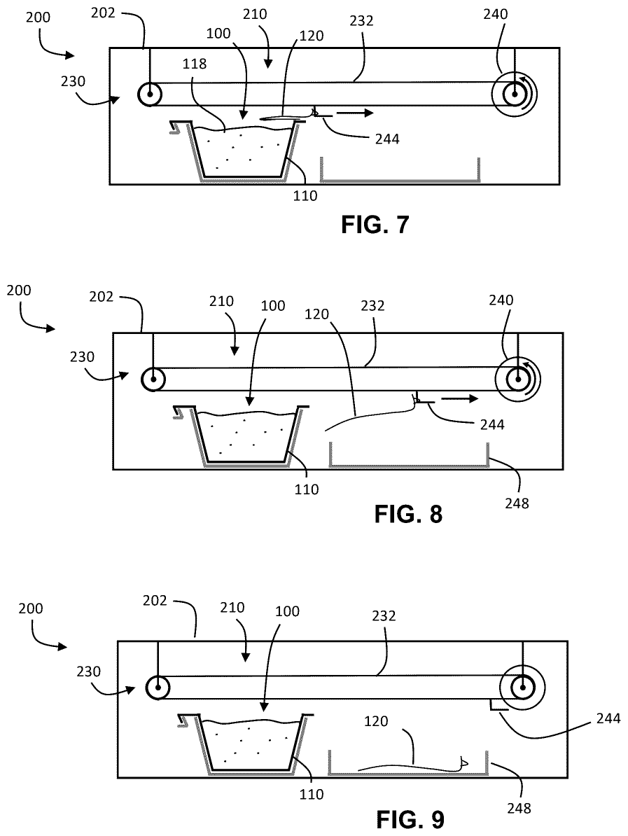

Referring to FIG. 7, continued actuation of the tab engaging element 244 along the trajectory continues to peel away the lid 120 from the rim 112 of the container portion 110, exposing the wet pet food 118 within the container portion 110. A perspective view of the mostly opened state of the pet food pod 100 at this stage of operation is provided in FIG. 11.

Referring to FIG. 8, continued actuation of the tab engaging element 244 by the lid removal actuator 240 causes the lid 120 to peel fully away (i.e., to be removed) from the container portion 110. The detached lid 120 may be carried away from the lid removal bay 210 towards the lid disposal tray 248 by the tab engaging element 244.

Referring to FIG. 9, the lid 120 has been dropped into the lid disposal tray 248 for eventual disposal. The mechanism that causes the lid 120 to be dropped may vary between embodiments. In one embodiment, the mechanism may cause a downward angling of tab engaging element 244 so that the loop 124 is dropped by the operation of gravity. In another embodiment, the loop 124 may be severed, e.g., by a static blade (not depicted).

The fully opened pet food pod 100 may thereafter be presented to a pet for consumption of the wet pet food 118. This may be done by conveying the container portion 110 to a feeding bay of the device 200, as described below. Alternatively, a panel or door (not depicted) in the body 202 of the device 200 may be automatically opened to provide access to the wet pet food 118.

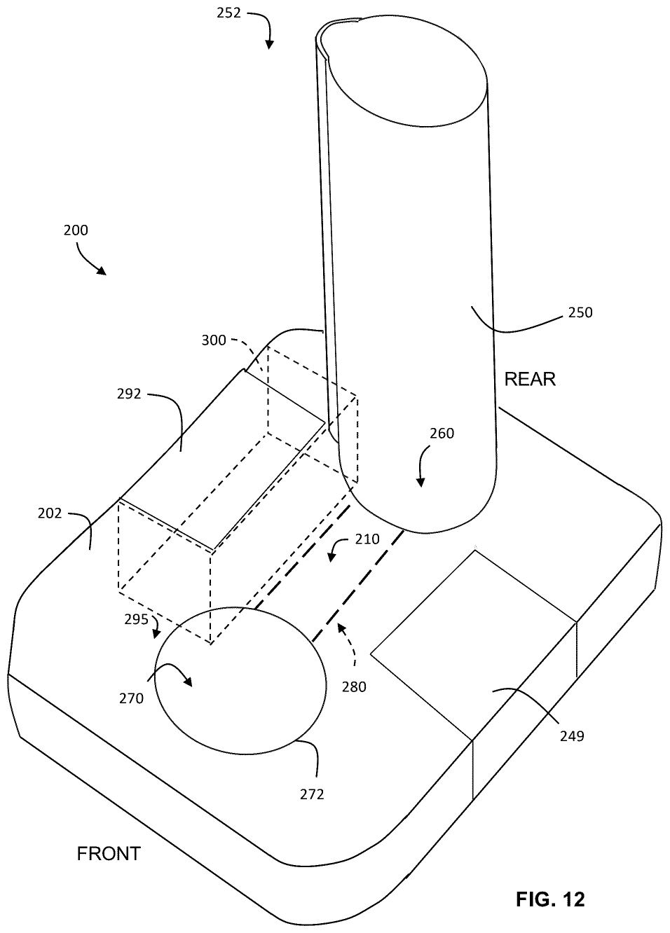

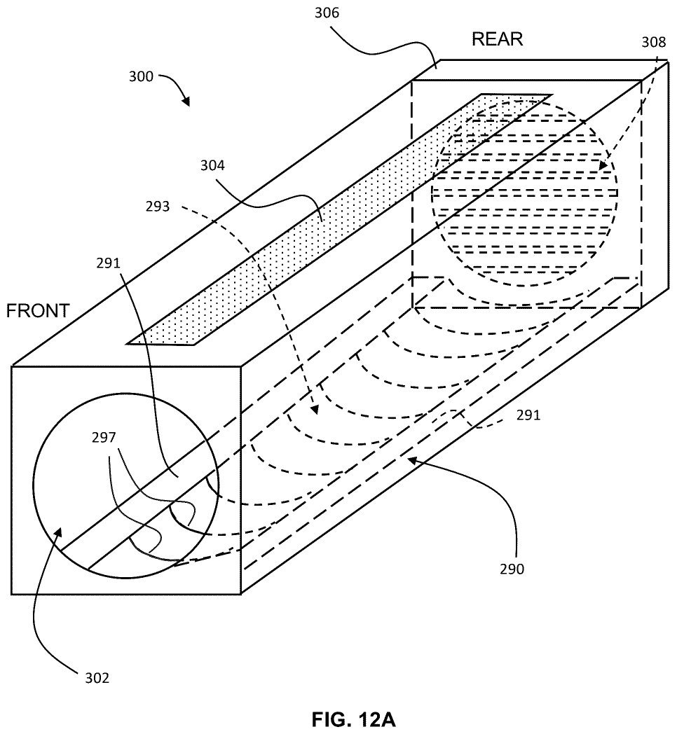

A front top right perspective view of one embodiment of device 200 is provided in FIG. 12. The device 200 depicted in FIG. 12 may be used with an embodiment of pet food pod 100′ that is depicted in side elevation view in FIG. 13 and in top view in FIG. 14.

As shown in FIGS. 13 and 14, the pet food pod 100′ has a container portion 110′ and a lid 120′. The container portion 110′ is generally bowl-shaped and has rim 112′. In the present embodiment, the rim 112′ is an outwardly projecting annular flange having a flat upper surface. A base 113′ of the container portion 110′ has two parallel grooves 115′ (e.g., channels) therein, which are shown end-on in FIG. 13. Each groove 115′ is straight and extends from one side of the base 113′ to the other.

A protrusion 114′ (e.g., a nub) extends laterally from the pet food pod 100′ on one side. The protrusion 114′ has an inwardly and upwardly sloped lateral face 117′, which has a curved profile in the present embodiment (but not necessarily in other embodiments). As will be appreciated, the face 117′ may facilitate engagement of a tab engaging element 244 of device 200 with a hook 124′ forming part of the pet food pod 100′ (described below).

The protrusion 114′ has an associated pod retention element 116′. The pod retention element 116′ may be used to facilitate immobilization of the pet food pod 100′ during removal of the lid 120′. In the present embodiment, the pod retention element 116′ is a flat ledge that extends laterally from a wall of the container portion 110′ immediately below protrusion 114′. The protrusion 114′ and pod retention element 116′ are both oriented substantially perpendicularly with respect to grooves 115′ (i.e., to the dimension in which the grooves 115′ are oriented).

The lid 120′ is formed of a moisture-impermeable material, such as foil or a foil material with a plastic undercoating. In the present embodiment, the lid 120′ has a generally circular body portion 121′ and an integral tab 122′ extending from a periphery of the body portion 121′ (i.e., a peripheral tab 122′). In the present embodiment, an inwardly and downwardly pointing hook 124′ is securely attached to an underside of tab 122′. The hook 124′, which may be curved and may, e.g., have a shape resembling that of a dorsal fin of a dolphin, can be used to facilitate lid removal as described below. As such, the hook 124′ may generically be referred to as a tab engagement facilitating portion 124′ of tab 122′.

The lid 120′ is peelably and hermetically sealed to the rim 112′ of the container portion 110′ to seal in the wet pet food (not expressly depicted). The lid 120′ may be sealed to the rim 112′ using a food-safe adhesive, which is not expressly depicted. The adhesive may be applied in a continuous ring that seals a periphery of the body portion 121′ of the lid 120′ to the upper surface of rim 112′. The extent of the lid 120′ may be less than an extent of rim 112′, i.e., the rim 112′ may protrude outwardly peripherally from underneath the body portion 121′ of lid 120′.

Referring to FIG. 12, the device has a body 202 made from a rigid material. A pod storage tower 250 sits atop the body 202, protruding upwardly from to the body 202. In this embodiment, the pod storage tower 250 is attached to an upper surface of the body 202 near a rear of the device 200. The pod storage tower 250 may be removably attached to the body 202 to facilitate cleaning of the tower 250 and/or body 202.

The pod storage tower 250 is configured to loosely receive a stack of pet food pods 100′. In the depicted embodiment, the pod storage tower 250 is generally cylindrical. In some embodiments, the pod storage tower 250 is made of a transparent material to allow a user to see the number of pet food pods 100′ stacked therein and to visually verify that the pods 100′ are not inadvertently flipped or otherwise misaligned so as to risk jamming device 200.

The pod storage tower 250 may have a pod alignment feature 252. In this embodiment, the pod alignment feature 252 is an outdent configured (e.g., sized and shaped) to accommodate loosely therewithin the tab 122′, protrusion 114′, and pod retention element 116′ of the pet food pod 100′ (see FIGS. 13 and 14). The pod alignment feature 252 may promote a uniform orientation of pet food pods 100′ that are stacked inside the pod storage tower 250.

In some embodiments, the pod storage tower 250 has a top hatch to selectively permit pet food pods 100′ to be loaded from the top. In some embodiments, a latchable side or rear door (not depicted) may be situated at or near the bottom of the pod storage tower 250. The latter door may permit manipulation of the pet food pods 100′ therewithin to correct any possible pod flipping or jamming issues. In some embodiments, the lower door may have a width equivalent to less than 100% (e.g., approximately 30%) of a diameter of the pod storage tower 250. This may be sufficient for a user to insert one or more fingers into the pod storage tower 250 to correct any possible pod jamming issues without risking spillage of any of the pet food pods 100 out through the door.

A receiving bay 260 may be disposed within the body below the pod storage tower 250. The receiving bay 260 may be configured to receive a pet food pod from the pod storage tower 250. The receiving bay 260 may include a pod lowering mechanism (not expressly depicted) for lowering a single pet food pod 100 at the lowest position of the pod storage tower 250 into the receiving bay 260. Operation of such a pod lowering mechanism is described below.

The lid removal bay 210, described above, is disposed within the body 202, e.g., adjacent to the receiving bay. In the present embodiment, the lid removal bay 210 is located substantially centrally within the body 202. The lid removal bay 210 is configured to receive a pet food pod 100 conveyed from the receiving bay 260. The lid removal bay 210 has an associated retainer 246, described above.

The lid disposal tray 248, described above, is located in the body 202 adjacent to the lid removal bay 210, which is at the right side of FIG. 12 in the present embodiment. A latchable lid removal access door 249 may permit the lid disposal tray 248 to be accessed and removed as necessary, e.g., for emptying and/or cleaning.

The lid removal mechanism 230, described above, is disposed within the body near the lid removal bay 210 and the lid disposal tray 248. The lid removal mechanism 230 is configured to actuate a tab engaging element 244, which in this embodiment is an L-shaped hook, along a trajectory from the lid removal mechanism 230 to the lid disposal tray 248.

The device 200 may further include a feeding bay 270 at which an opened pet food pod 100′ may be presented to a pet for feeding. In the present embodiment, the feeding bay 270 is located near the front of the device 200. The feeding bay 270 may include an opening in the body 202 that is surrounded by an inwardly facing lip 272. The opening may be circular. The lip 272 may be configured to cover the rim 112′ of the opened pet food pod 100′ to prevent pod removal during feeding. The lip does not obstruct pet access to the wet pet food 118.

The device 200 may further include a conveyor 280 within the body 202. The conveyor 280 may be operable to convey a pet food pod 100′ from the receiving bay 260 to the lid removal bay 210, and in some embodiments, subsequently from the lid removal bay 210 to the feeding bay 270. The conveyor 280 may include a pair of rails (not expressly depicted) along which the pet food pod 100′ may be conveyed, e.g., between the receiving bay 260 and the lid removal bay 210. The rails may be spaced apart suitably for alignment with the grooves 115′ on the underside of a pet food pod 100′. Seating of the grooves 115′ on the rails may facilitate the maintaining of a desired orientation of the pet food pod 100′ as it is translated along the rails. Maintaining a particular orientation of the pet food pod 100′ may promote a desired interaction with other device components such as the retainer 246 and the lid removal mechanism 230, e.g., as described above.

The device 200 may further include a removable pod disposal tray 290. The purpose of the pod disposal tray 290 is to hold one or more used pet food pods 100′. For clarity, the term “used pet food pods” herein refers to substantially empty pet food pod container portions after the wet pet food 118 therein has been substantially consumed by a pet. The pod disposal tray 290 may be part of a pod disposal chamber 300 within the body 202 of the device 200. The pod disposal chamber 300 (and thus the pod disposal tray 290) may be located on an opposite side of the body 202 from the lid disposal tray 248, as shown in FIG. 12. An example pod disposal chamber 300 is schematically depicted in FIG. 12A in isolation.

Referring to FIG. 12A, the pod disposal chamber 300 of the present embodiment is a cuboid chamber that receives and stores used pet food pod containers. In the depicted embodiment, the pod disposal chamber 300 has an opening 302 at its front end—which may be oriented toward the front of the body 202 of the device 200—through which the used pods may be received.

The pod disposal tray 290 may be located at the bottom of the pod disposal chamber 300. The pod disposal tray 290 may be defined by a floor 293 flanked by a pair of longitudinal curbs 291. In the depicted embodiment, the floor 293 is recessed downwardly relative to the curbs 291, i.e., is lower than the curbs 291. The floor 293 of the present embodiment is curved in the transverse dimension. In some embodiments, the floor 293 may be sloped upwardly towards a rear of the pod disposal chamber 300. In some embodiments, the floor 293 may have crosswise (transverse) grooves 297 or ridges along its length, as depicted in FIG. 12A, for reasons that will be described below. In some embodiments, the pod disposal tray 290 may be a tray with walls and a floor.

The example pod disposal chamber 300 of FIG. 12A includes a disinfecting light source 304. The light source is operable to emit light, such as ultraviolet light, into an interior of the chamber 300 to facilitate sanitizing of the chamber 300 and the surfaces of any pods contained therewithin.

The example pod disposal chamber 300 further includes a fan unit 306 at the rear of the pod disposal chamber 300 to facilitate ventilation thereof. The fan unit 306 includes an electric fan (not expressly depicted) adjacent to a vented opening 308. A replaceable air filter (not expressly depicted) may be insertable into a receptacle adjacent to the vented opening 308, which may be accessible through an opening in body 202. The filter may be removably secured within the device, e.g., using a friction fit, a clipping mechanism, or a fastener, such as one or more snaps, screws, magnets, or hook-and-loop fasteners. The air filter may be positioned in an airflow path of the fan and may incorporate an agent, such as baking soda and/or activated carbon, to facilitate absorption and/or neutralization of odors.

A latchable door 292 (FIG. 12) may selectively provide user access to the pod disposal chamber 300 for removal of pod disposal tray 290, e.g., for emptying and/or cleaning. The latch may be designed so that opening by a house pet is difficult or impossible. A second conveyor 295 may be configured to convey an empty or substantially empty pet food pod 100′ from the feeding bay 270 to the pod disposal tray 290.

The device 200 may operate as follows, e.g., automatically under the control of a controller (not expressly depicted). At a predetermined feeding time, the pod lowering mechanism may retrieve a lowermost pet food pod 100′ from the pod storage tower 250. In some embodiments, the pod lowering mechanism may include an opposed pair of curved arms (not depicted). The curved arms may be operable to hug and hold the pet food pod 100′ from opposite sides and to lower the pet food pod 100 gently into the receiving bay 260. Lowering may be preferable to freefall dropping of the pet food pod 100 to reduce a risk of pod misorientation within the receiving bay 260. The curved arms may be configured to move apart to disengage the pet food pod 100 when the pet food pod 100 has been lowered into the receiving bay 260. The arms may thereafter move back up in preparation for lowering the next pet food pod 100 in the future.

By virtue of the pod alignment feature 252 of the pod storage tower 250, the orientation of the lowered pet food pod 100′ will be such that the grooves 115′ in the base 113′ of the pet food pod 100′ align with (e.g., receive respective ones of) the rails of the conveyor 280. The relative sizing of the grooves 115′ relative to the rails may provide for a margin of error for possible misalignment as the pod 100′ is lowered onto the rails. For example, the rails may be thinner underneath the pod storage tower 250 and may increase in thickness towards the lid removal bay 210. The rails may be considered as a form of track.

In a subsequent operation, the controller may cause the pet food pod 100′ to be conveyed along the track from the receiving bay 260 to the lid removal bay 210. More specifically, the pet food pod 100′ may be conveyed (translated) along the rails by two arms situated alongside (e.g., on opposite side of) the track that may be used to push pod 100 along the rails of the conveyor 280. The arms may be curved to receive respective opposed portions of the pod 100′, i.e., to cradle the pod 100′ from opposite side. The widening rails may correct any minor initial misalignment of the pet food pod 100′ as it is conveyed towards and into the lid removal bay 210. This may reduce any possible shifting, and may promote proper alignment, of the pet food pod 100′ upon being received at the lid removal bay 210.

At the lid removal bay 210, the pet food pod 100′ may be substantially immobilized as follows. The pod retention element 116′ may be positioned in alignment with a retainer 246 forming part of device 200. For the embodiment of pod 100′ depicted in FIGS. 13 and 14, the retainer 246 may be a shelf-like structure in fixed relation to the body 202 of the device 200. The retainer 246 may be sized and positioned so as to occupy a space immediately above pod retention element 116′, e.g., as shown in FIG. 13, when the pod 100′ is in position within the lid removal bay 210. The retainer 246 may be positioned just above the pod retention element 116′ so as to substantially limit or prevent lifting up of the pod retention element 116′ during lid removal. In the embodiment depicted in FIG. 13, there is a space (gap) above the retainer 246 and below tab engagement facilitating portion (hook) 124′ that is sufficiently large to receive the portion 245 of tab engaging element 244 during lid removal.

In some embodiments, additional elements of the device 200, e.g., a fixed pair of rails (not depicted), may engage with other portions of the pod 100′ to help substantially immobilize the pod 100′ in the lid removal bay 210 during lid removal. For example, the rails may be positioned so as to overhang the areas 123, 125 of the upper surface of the protruding portion of rim 112′ on opposite sides of the pod 100′ immediately above rim 112′. This may further help to limit or prevent upward lifting of the container portion 110′ during lid removal.

Thereafter, the controller may activate the lid removal mechanism 230 to initiate removal of the lid 120′. Operation of the lid removal mechanism 230 may be similar to what is described above. For the pet food pod 100′ shown in FIGS. 13 and 14, the tab engaging element 244 component of the lid removal mechanism 230 may be an L-shaped hook. The orientation of the L-shaped hook may be crosswise relative to the hook 124′ on the underside of tab 122′. In other words, the orientation may be as shown in FIG. 13, in which the straight lower leg 245 (i.e., the portion 245) of the L-shaped hook (i.e., of tab engaging element 244) is shown end-on.

As the tab engaging element 244 moves towards the pet food pod 100′, the lower leg 245 of the L-shaped hook may pass between the hook 124′ and the retainer 246 (the latter being immediately above pod retention element 116′). Upon contacting and riding up the inwardly and upwardly sloped lateral face 117′ of nub 114′, the lower leg 245 of tab engaging element 244 may press upwardly against the underside of the tab 122′. This may initiate a prying away of the tab 122′ from the nub 114′ and generally away from container portion 110′. Further translation of the tab engaging element 244 may cause the tab 122′ to fold over the container portion 110′. Folding of the tab 122′ may cause the hook 124′ to become inverted with its tip pointing to the left in FIG. 13. At that stage, further translation of the tab engaging element 244 along its trajectory may cause the lower leg 245 of the tab engaging element 244 to engage with hook 124′. Further translation of the tab engaging element 244 to the right of FIG. 13 may pull the hook 124′ and tab 122′ along with it, peeling the lid 120′ away from the container portion 110′ in a similar manner to what was earlier described in connection with FIGS. 4-9.

When the removed lid 120′ is above the lid disposal tray 248, it may be dropped therein. In some embodiments, the tab engaging element 244 may be retractable. Retraction may cause the hook 124′ to slide off the lower leg 245. In some embodiments, a fixed member within the body 202 can push the lid 120′ off the tab engaging element 244.

After the lid 120′ has been removed from the container portion 110′ and dropped into the lid disposal tray 248, the now opened pet food pod 100′ may be conveyed from the lid removal bay 210 to the feeding bay 270 to be presented to the pet for feeding. The conveying mechanism used to convey the pet food pod 100 to the feeding bay 270 may be similar to, or different from, what was used to convey the pet food pod 100′ from the receiving bay 260 to the lid removal bay 210.

During conveyance to the feeding bay 270, the pet food pod 100′ need not necessarily be maintained in the same orientation that it had assumed in the lid removal bay 210. Thus, the conveyor in some embodiments could convey the pet food pod 100′ with its base 113′ on a flat surface versus rails, which may permit rotation of the pet food pod 100′ to occur during conveyance.

The opened pet food pod 100′ may be left in the feeding bay 270 for a predetermined amount of time that is sufficient for a pet to feed. In some embodiments, the device 200 may generate a predetermined notification, e.g., an auditory notification, when the wet pet food 118 has been presented for consumption. A house pet may come to associate the notification with newly available food. This may encourage timely consumption of wet pet food while it is fresh.

After a predetermined feeding interval, the controller may activate the second conveyor 295 to convey the empty, or substantially empty, used pet food pod 100′ to the pod disposal chamber 300. The pod disposal chamber 300 may have an associated compactor mechanism (not expressly depicted). The compactor mechanism may be used to push the at least substantially empty pod container portion through the opening 302 (FIG. 12A) toward a rear area of the pod disposal chamber 300 and/or to compact the at least substantially empty pod container portion(s) to maximize available storage space therewithin. As the pet food pod 100′ is pushed rearwardly within the tray, it may become upwardly angled in view of the angled floor of the pod disposal tray 290. The angle may be about 25 to 30 degrees to minimize spillage from any uneaten food.

The rim 112′ of the angled pet food pod 100′ may come into contact with a floor 293 of the pod disposal tray 290 and may become caught on one of the grooves 297 or ridges in the floor. The grooves 297 or ridges may be configured (e.g., the grooves may be made to have a predetermined depth and/or width) to so catch the rim 112′. This may prevent or limit slipping of the pet food pod 100′ back towards a front of the pod disposal chamber 300 and/or pod disposal tray 290.

The controller thereafter may activate the disinfecting light source 304 and/or fan within fan unit 306 for a set duration after initial disposal of a pet food pod 100′ and/or at various intervals thereafter, until the pod disposal tray 290 is emptied. The rationale for such activation of the fan may be to expedite drying of any food remnants to delay spoilage and limit malodor.

In some embodiments, the device 200 may have an associated software application (app). The app may communicate with the embedded controller, e.g., to provide user notification regarding the status of the device 200. The app may also allow the user to customize a pet's feeding plan or to override the plan on demand. The app may also provide a purchasing tool for customers to order pods automatically once a feeding plan has been chosen.

In some embodiments, the device 200 may incorporate a scale at the feeding bay 270 to monitor food consumption by weight. The app may be operable to provide the pet owner with data regarding the timing and amount of wet pet food consumption over time, e.g., by tracking patterns of food consumption. The app may provide a user indication if the pattern has changed by a predetermined amount, which may be a warning sign of an underlying health condition of a pet.

The design of device 200 should be robust yet safe for pets. There should not be parts where pets can get stuck or injure themselves, but it should also be difficult for pets to knock over the device 200 or to remove the tower 250 to access the pods.

In some embodiments, the device 200 should be reliable enough to work on without human intervention for at least two to three days. This may include limiting the chance of failure from interference from pets and ability to “unjam” or reset itself in case of a failure. In the case of a failure that cannot be automatically resolved, some embodiment of device 200 should be operable to trigger a user notification, e.g., via the app.

Various alternative embodiments are possible.

In some embodiments, the tab engaging element may be something other than an L-shaped hook. For example, in some embodiments, the tab engaging element may be a ring designed to engage a complementary tab engagement facilitator portion (e.g., a hook or tooth) of the peripheral tab of the pet food pod lid. In some embodiments.

In some embodiments, the pod retention element may be something other than a downwardly and inwardly angled lip or a flat ledge. The characteristics of the pod retention element may be based on (e.g., may be complementary to) the characteristics of the retainer to be used to substantially immobilize the pet food pod during lid removal. For example, in some embodiments, the pod retention element may be a lip or flange projecting laterally from a base of the container portion of the pet food pod. For such embodiments, the retainer may be an opposed pair of horizontal grooves in respective walls on opposite sides of a track within which the lip or flange may be slidably received.

What is claimed is:

1. A device for automatically serving wet pet food, the device comprising:
a body;
a lid removal bay in the body, the lid removal bay configured to receive a pet food pod, the pet food pod including a container portion containing wet pet food, the container portion being generally bowl-shaped and having a rim, the pet food pod further including a lid peelably and hermetically sealed to the rim, the lid having a peripheral tab;
a tab engaging element configured to engage the peripheral tab;
a lid removal actuator in the body, the lid removal actuator operable to, upon receipt of the pet food pod within the lid removal bay, actuate the tab engaging element along a trajectory over the pet food pod so that the tab engaging element will engage and pull the peripheral tab across the container portion to cause the lid to peel away from the rim, resulting in an open container portion with exposed wet pet food; and
a retainer configured to substantially immobilize the pet food pod within the lid removal bay during lid removal by the tab engaging element.

2. The device of claim 1 further comprising:
a pod storage tower removably attached to the body, the pod storage tower for receiving a stack of the pet food pods.

3. The device of claim 2 wherein the pod storage tower includes a pod alignment feature for promoting a uniform orientation of the pet food pods in the stack received in the pod storage tower.

4. The device of claim 2 further comprising:
a receiving bay in the body below the pod storage tower, the receiving bay configured to receive a pet food pod from the pod storage tower; and
a pod lowering mechanism for lowering a lowermost pod from the pod storage tower into the receiving bay.

5. The device of claim 4 further comprising a conveyor operable to convey a pet food pod from the receiving bay to the lid removal bay.

6. The device of claim 5 wherein the conveyor substantially maintains an orientation of the pet food pod during conveyance.

7. The device of claim 5 wherein the conveyor comprises a pair of parallel rails, wherein the container portion of the pet food pod has a base with a pair of straight parallel grooves formed in an underside of the base, and wherein the conveyor is operable to slidably translate the pet food pod atop the pair of parallel rails with each of the grooves seated on a respective one of the rails.

8. The device of claim 1 further comprising:
a lid disposal tray within the body adjacent to the lid removal bay, the lid disposal tray being configured to hold a plurality of lids after removal of the lids from respective ones of the pet food pods.

9. The device of claim 1 further comprising:
a feeding bay in the body configured to receive the open container portion of a pet food pod that has been conveyed from the lid removal bay, the feeding bay including an opening in a top surface of the body, the opening being surrounded by an inwardly facing lip, the lip being configured to obstruct pod removal from the feeding bay without obstructing access to wet pet food within the container portion.

10. The device of claim 9 further comprising:
a pod disposal chamber configured to receive a plurality of pet food pod container portions, in a substantially empty state, conveyed from the feeding bay.

11. The device of claim 10 further comprising:
a compactor mechanism operable to compact the plurality of pet food pod container portions, in the substantially empty state, within the pod disposal chamber.

12. The device of claim 10, wherein the pod disposal chamber includes a removable pod disposal tray having a pair of longitudinal curbs and a floor between the curbs recessed downwardly relative to the curbs.

13. The device of claim 10, wherein the pod disposal chamber includes a removable pod disposal tray having a floor and a plurality of crosswise grooves or ridges on the floor, each of the crosswise grooves or ridges being configured to catch the rim of a respective one of the pet food pod container portions to discourage slippage of the pet food pod container portion towards a front of the pod disposal tray.

14. The device of claim 1 further comprising:
a fan within the body; and
a removable filter positioned in the airflow path of the fan, the removable filter configured to absorb or neutralize odors from air circulated by the fan, the filter being removably secured within the device.
